(19) United States
(12) Patent Application Publication
(10) Pub. No.: US 2026/0350412 A1
(43) Pub. Date: Nov. 5, 2026

(54) TRANSFER LEARNING FOR TRAINING ARTIFICIAL INTELLIGENCE MODELS WITH IMAGES FROM IMAGING FLOW CYTOMETERS

(71) Applicant: Cytek Biosciences, Inc., Fremont, CA (US)

(72) Inventors: Vidya Venkatachalam, Seattle, WA (US); Maxwell H. Gray, Seattle, WA (US)

(73) Assignee: Cytek Biosciences, Inc., Fremont, CA (US)

(21) Appl. No.: 19/546,409

(22) Filed: Feb. 22, 2026

Related U.S. Application Data
(63) Continuation-in-part of application No. 18/749,606, filed on Jun. 20, 2024.
(60) Provisional application No. 63/761,976, filed on Feb. 22, 2025.

(51) Int. Cl. G06N 3/096; G01N 15/1433; G06N 3/0464; G06N 3/0985; G06V 10/70; G06V 10/82

(52) U.S. Cl. CPC G06N 3/096; G01N 15/1433; G06N 3/0464; G06N 3/0985; G06V 10/82; G06V 10/87

(57) ABSTRACT

Methods of speeding the training of a convolutional neural network (CNN) to classify new images of biological cells captured by an imaging flow cytometer (IFC) are disclosed. Transfer learning with and without mapping is used based on the selection of pre-trained CNN to be used. New images of biological cells can be classified with new classes that are provided such as classes for red blood cells and classes for DNA damage of lymphoma biological cells.

### CROSS-REFERENCE TO RELATED APPLICATIONS

This patent application claims the benefit of U.S. Provisional Patent Application No. 63/761,976 titled TRANSFER LEARNING FOR TRAINING ARTIFICIAL INTELLIGENCE MODELS WITH IMAGES FROM IMAGING FLOW CYTOMETERS filed by inventors Vidya Venkatachalam et al. on Feb. 22, 2025, incorporated herein for all intents and purposes. This patent application is a continuation in part and claims the benefit of U.S. patent application Ser. No. 18/749,606 titled ARTIFICIAL INTELLIGENCE ANALYSIS FOR IMAGING FLOW CYTOMETRY filed by inventors Vidya Venkatachalam on Jun. 20, 2024, incorporated herein for all intents and purposes. U.S. patent application Ser. No. 18/749,606 claims the benefit of U.S. Provisional Patent Application No. 63/522,133 titled “ARTIFICIAL INTELLIGENCE FOR IMAGING FLOW CYTOMETRY” filed on Jun. 20, 2023, by inventor Vidya Venkatachalam et al., incorporated herein for all intents and purposes. This patent application claims the benefit of U.S. Provisional Patent Application No. 63/522,398 titled “METHODS OF ARTIFICIAL INTELLIGENCE FOR IMAGING FLOW CYTOMETRY” filed on Jun. 21, 2023, by inventor Vidya Venkatachalam et al., incorporated herein for all intents and purposes. This patent application claims the benefit of U.S. Provisional Patent Application No. 63/522,400 titled “SYSTEMS FOR ARTIFICIAL INTELLIGENCE FOR IMAGING FLOW CYTOMETRY” filed on Jun. 21, 2023, by inventor Vidya Venkatachalam et al., incorporated herein for all intents and purposes.

This patent application is further a continuation in part and claims the benefit of U.S. patent application Ser. No. 18/647,366 titled COMBINING BRIGHTFIELD AND FLUORESCENT CHANNELS FOR CELL IMAGE SEGMENTATION AND MORPHOLOGICAL ANALYSIS IN IMAGES OBTAINED FROM AN IMAGING FLOW CYTOMETER filed by inventors Alan Li et al on Apr. 26, 2024, incorporated herein for all intents and purposes. U.S. patent application Ser. No. 18/647,366 is a continuation of U.S. patent application Ser. No. 17/076,008 titled METHOD TO COMBINE BRIGHTFIELD AND FLUORESCENT CHANNELS FOR CELL IMAGE SEGMENTATION AND MORPHOLOGICAL ANALYSIS USING IMAGES OBTAINED FROM IMAGING FLOW CYTOMETER (IFC) filed by inventors Alan Li et al on Dec. 16, 2022, incorporated herein for all intents and purposes.

This application incorporates by reference U.S. patent application Ser. No. 17/016,244 titled USING MACHINE LEARNING ALGORITHMS TO PREPARE TRAINING DATASETS filed on Sep. 9, 2020, by inventors Bryan Richard Davidson et al. for all intents and purposes. For all intents and purposes, Applicant incorporates by reference in their entirety the following U.S. Pat. Nos.: 6,211,955, 6,249,341, 6,256,096, 6,473,176, 6,507,391, 6,532,061, 6,563,583, 6,580,504, 6,583,865, 6,608,680, 6,608,682, 6,618,140, 6,671,044, 6,707,551, 6,763,149, 6,778,263, 6,875,973, 6,906,792, 6,934,408, 6,947,128, 6,947,136, 6,975,400, 7,006,710, 7,009,651, 7,057,732, 7,079,708, 7,087,877, 7,190,832, 7,221,457, 7,286,719, 7,315,357, 7,450,229, 7,522,758, 7,567,695, 7,610,942, 7,634,125, 7,634,126, 7,719598, 7,889,263, 7,925,069, 8,005,314, 8,009,189, 8,103,080, 8,131,053, 8,175,371, and 8,571,294.

### FIELD

The embodiments relate generally to artificial intelligence for images of flowing biological cells in a fluid captured by an imaging flow cytometer.

### SUMMARY

In some aspects, the techniques described herein relate to a method of speeding the training of a convolutional neural network (CNN) to classify images of biological cells captured by an imaging flow cytometer (IFC). The method includes: selecting a trained non-imaging flow cytometer convolutional neural network (CNN) from which to acquire trained non-IFC parameters; receiving the trained non-IFC parameters from the trained non-IFC CNN; transfer learning a plurality of the trained non-IFC parameters to form initial network parameters for a first trained IFC CNN; receiving new biological images from a first IFC dataset; receiving new classes to classify the new biological images in the IFC dataset; and optimizing the first trained IFC CNN to form a second trained IFC CNN for biological images similar to the first IFC data.

In some aspects, the techniques described herein relate to a method, wherein the transfer learning a plurality of the trained non-IFC parameters to form initial network parameters for a first trained IFC CNN includes: mapping the trained non-IFC parameters into mapped non-IFC parameters to form the initial network parameters for the first trained IFC CNN.

In some aspects, the techniques described herein relate to a method, wherein the mapping is one or more of an averaging of the trained non-IFC parameters to form the mapped non-IFC parameters; and a normalizing of the trained non-IFC parameters to form the mapped non-IFC parameters.

In some aspects, the techniques described herein relate to a method, wherein the new biological images in the first IFC dataset are captured with an imaging flow cytometer.

In some aspects, the techniques described herein relate to a method, wherein the new biological images are multispectral type images of multiple channels including brightfield images in brightfield channel and fluorescent images in one or more fluorescent channels.

In some aspects, the techniques described herein relate to a method, wherein the trained non-imaging flow cytometer CNN was trained using non-biological images in a different image type than the new biological images. The non-biological images can be in a red, green, and blue (RGB) image type associated with digital cameras.

In some aspects, the techniques described herein relate to a method of speeding the training of a convolutional neural network (CNN) to classify images of biological cells captured by an imaging flow cytometer (IFC). The method includes: selecting a pretrained imaging flow cytometer convolutional neural network (CNN) from which to acquire pretrained IFC parameters; receiving the pretrained IFC parameters from the pretrained IFC CNN; transfer learning a plurality of the pretrained IFC parameters to form initial network parameters from which to retrain the pretrained IFC CNN; receiving a plurality of new biological images from a second IFC dataset; receiving one or more new classes to classify the new biological images in the second IFC dataset; and optimizing the pretrained IFC CNN to form a retrained IFC CNN for biological images similar to the first IFC data based partly on the one or more new classes and the new biological images in the second IFC dataset.

In some aspects, the techniques described herein relate to a method, wherein a plurality of IFC images of biological cells in a first IFC data set are used to train the pretrained IFC CNN and differ from the plurality of IFC images of biological cells in the second IFC data set.

In some aspects, the techniques described herein relate to a method, wherein a number of the new IFC images in the second IFC dataset is one of at least ten or more; twenty or more, twenty-five or more, thirty or more, thirty-five or more, forty or more, forty-five or more, and/or fifty or more.

In some aspects, the techniques described herein relate to a method, wherein a number of the new IFC images of biological images in the second IFC dataset is substantially less than a number of the plurality of IFC images of biological cells in a first IFC data set to speed training.

In some aspects, the techniques described herein relate to a method, wherein the new IFC images of biological cells in the second IFC dataset are captured with an imaging flow cytometer and the plurality of IFC images of biological cells in the first IFC data set are captured with the imaging flow cytometer.

In some aspects, the techniques described herein relate to a method, wherein the new IFC images of biological cells in the second IFC dataset are red blood cells.

In some aspects, the techniques described herein relate to a method, wherein the new classifications (classes) to classify the biological cells in the second IFC dataset are one or more of Discocytes, Echinocytes 1 and Echinocytes 2, Stomatocytes, and Sideways cells.

In some aspects, the techniques described herein relate to a method, wherein the new IFC images of biological cells in the second IFC dataset are a mixture of healthy biological cells and lymphoma biological cells with DNA damage.

In some aspects, the techniques described herein relate to a method, wherein the new classifications (classes) to classify the biological cells with DNA damage in the second IFC dataset are Binucleated (BNC), Mitotic, Mononucleated, Mononucleated with micronuclei; and Irregular.

In some aspects, the techniques described herein relate to a method for training a convolutional neural network (CNN) to classify images of biological cells captured by an imaging flow cytometer (IFC) using transfer learning as shown in the figures and described in the detailed description.

In some aspects, the techniques described herein relate to a method for training a convolutional neural network (CNN) to classify images of biological cells captured by an imaging flow cytometer (IFC), including: with a user interface wizard displayed on a display device, walking a user through setting up a training experiment in a training mode to train a new model for a desired experiment type on biological cells in a sample; and running a classification experiment in a classification mode to classify cells by cell type and cell morphology with new high resolution multispectral cellular image data.

In some aspects, the techniques described herein relate to a method, further including running a plurality of differing biological cells in a biological sample in a stream of fluid through an imaging flow cytometer to capture the new high resolution multispectral cellular image data for the plurality of differing biological cells.

### BRIEF DESCRIPTION OF DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1A is a schematic illustration of an exemplary flow imaging system for implementing the concepts disclosed herein;

FIG. 1B is a block diagram of an embodiment of an artificial intelligence (AI) imaging flow cytometer system.

FIG. 2 illustrates an example convolutional neural network (CNN) and how it can be trained for image processing of biological cells with various algorithms.

FIG. 3A is a flow chart of transfer learning for a convolutional neural network (CNN) to perform image analysis of images of biological cells captured with an imaging flow cytometer.

FIG. 3B is a flow chart of transfer learning for a convolutional neural network (CNN) to perform image analysis of images of biological cells captured with an imaging flow cytometer.

FIG. 4 illustrates a flow chart of a method of transfer learning and AI training of a new model with imaging flow cytometer images captured by an imaging flow cytometer.

FIG. 5 is a chart of plots of prediction accuracy for various AI models for comparison over the given number of examples per class.

FIG. 6 are matrices of statices regarding class prediction performance and confusion.

FIG. 7 is a table that shows average precision and recall metrics for each class of three AI models.

FIG. 8 shows representative bright-field images of five classifications (classes) of red blood cells.

FIGS. 9A-9C illustrate bright field images for three common misclassifications made by the transfer-learned model using the imaging flow cytometer (IFC) images as the data for its source model.

FIG. 10 illustrates shows representative bright-field images of five classes of DNA damage of cells that models can be trained by transferred learning to detect and measure cancer cells.

FIG. 11A is a table illustrating statistical prediction of DNA damage classification using a Chinese Hamster Ovaries (CHO) AI model applied to a predetermined L5178Y cell line.

FIG. 11B is a table illustrating statistical prediction of DNA damage classification using a transfer learning model formed using 50 cells from the predetermined L5178Y cell line.

FIGS. 12-15 are window portions of graphical user interfaces (GUI) displayed on a display device to create a new model and a new experiment to analyze new IFC images of biological cells with the AI image analysis device/software.

### DETAILED DESCRIPTION

In the following detailed description of the disclosed embodiments, numerous specific details are set forth in order to provide a thorough understanding. However, it will be obvious to one skilled in the art that the disclosed embodiments may be practiced without these specific details. In other instances, well known methods, procedures, components, and subsystems have not been described in detail so as not to unnecessarily obscure aspects of the disclosed

### Convolutional Neural Network

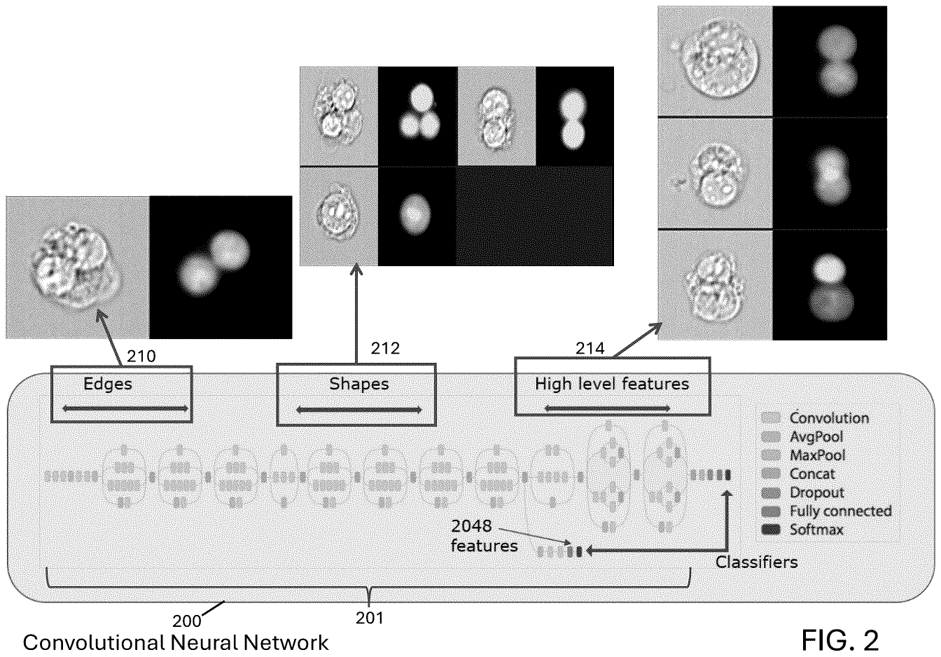

Referring now to FIG. 2, an AI algorithm that can be used to process multispectral cellular images from an imaging flow cytometer (IFC) is a convolutional neural network (CNN) 200. A convolutional neural network handles the high dimensionality of images by convolving over each image to learn its features and maintains all the spatial data available. The CNN also utilizes a deep learning architecture however this makes it what's called a black box solution which means that they're not explainable. You can't step through the logic on a piece of paper to outline exactly how a CNN receives an input image and generates the output results classification or label of the cellular image into one or more classes.

CNNs are an industry standard in image classification. They are composed of multiple building blocks that are designed to automatically and adaptively learn spatial hierarchies of features. This enables them to handle the high dimensionality of images very well and of course as mentioned, this is what results in that black box solution. While highly effective in handling two dimensional imagery, CNNs take longer to train especially as the size of the input image grows. Thus, the CNN takes longer to train than other numeric based algorithms. The CNN in the AI Analysis software is fully optimized for biological imagery. It is pretrained to handle a diverse set of biological applications that a user is interested in with the images captured by an imaging flow cytometer.

A CNN has multiple layers 201 (shown from left to right in FIG. 2) to process the multispectral cellular images and obtain desired image features. For example, in the earlier layers of the CNN (left side), the CNN can learn about the edges 210 of the cell using the multispectral image. Moving deeper into layers 201 of the CCN, other features can be discovered about the cell from the multispectral image, such as the shape(s) 212 of the cell. Moving into the deepest layers of the CNN (right side), high-level image features 214 can be determined from the multispectral image. Convolution of the image and the prior training of the parameters of the CNN makes extraction of image features possible. CNNs maintain all spatial data from input images and require no additional manual intervention to train. Because they use deep learning architectures, CNNs offer a specialized, deep learning method for image classification. CNNs are often considered a “black box” solution to image classification. Training a CNN from scratch requires numerous images and takes considerable computer time. It is desirable to speed training of CNN models for analyzing biological cells.

### Transfer Learning

Transfer learning (TL) is a training technique where a model trained for a specific task (or on a specific dataset) can be optimized to learn a new but related task (using additional ground truth objects). This is helpful when there is insufficient data to train a new model. A pre-trained model (which may be an AMNIS AI model or an external model) can be fine-tuned on the new data with fewer objects in the ground truth population. Transfer learning can build a new convolutional neural network (CNN) model off of an existing trained CNN model and require much less training data. For example, a CNN-only training experiment without using transfer learning, the minimum truth requirement is 100 objects/class. Using transfer learning with the same CNN-only training experiment, the minimum truth requirement is 25 objects/class. With fewer objects/classes to use to train a model, it is significantly faster to train a new model using transfer learning. Furthermore, transfer learning also expands the applicability of CNNs to address sample variations, rare populations, and new users.

Transfer learning (TL) is a machine learning approach that allows the practitioner to leverage existing, pre-trained algorithms for improved performance on relatively small, domain-specific datasets. For example, due to the focus on images of objects like dogs, houses, food items, etc., there are many datasets with these types of classes that have been hand labeled (ImageNet′ is a popular example). For problems like classifying the phenotype of a blood cell based on the output of an imaging flow cytometer, the data available has often been collected by a lab without the resources for this kind of work. The fundamental assumption of TL is that the larger the dataset that the pre-trained model has learned to classify, the better the algorithm will have learned to extract well-formed features. Therefore, this provides a useful starting point for training on data with a similar distribution.

Transfer learning can be applied to imaging flow cytometry (IFC) datasets, with a particular focus on how the data distribution of a pre-trained model affects the performance of the resulting domain specific model. In particular, the models can be trained to classify red blood cells (RBCs) with five phenotypes: Discocytes, Echinocytes (separated into two classes based on their morphology), Stomatocytes, and Sideways cells. These five phenotypes can be used as the classes. Sideways cells in the cell images are cells that are passed by the imager without showing a flat side. In another case, the models can be trained to measure DNA damage of cells.

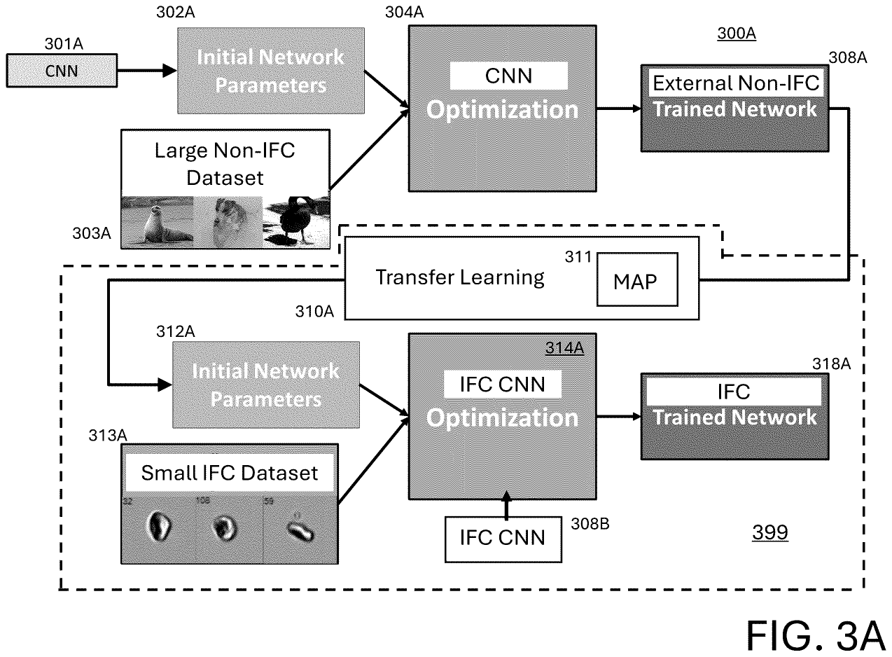

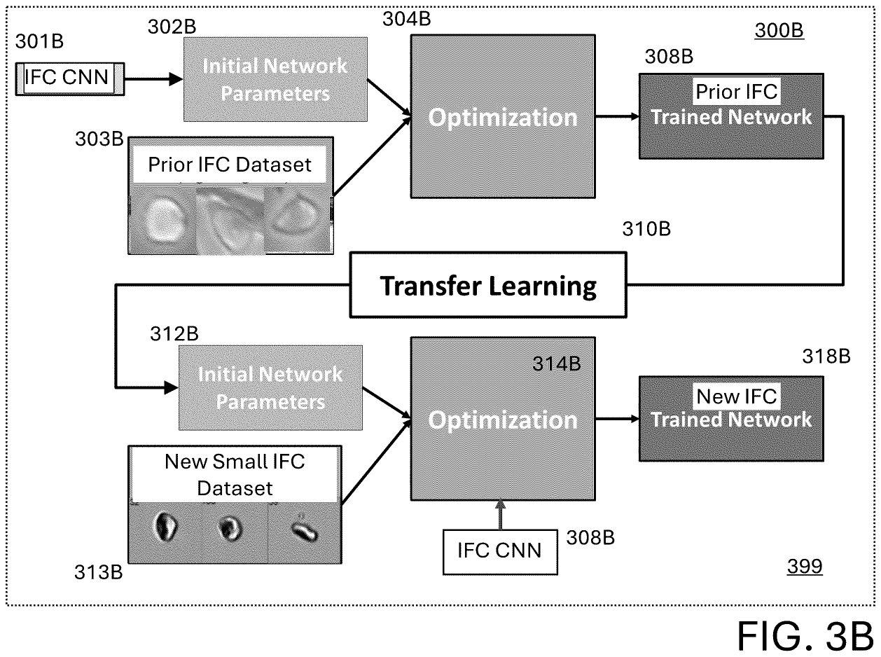

FIGS. 3A-3B generally shows flow charts of transfer learning. FIG. 3A illustrates an external non-imaging flow cytometer trained convolutional neural network 308A being used with transfer learning 310A, including a mapping algorithm 311, to form a new imaging flow cytometer trained convolutional neural network 318A. FIG. 3B illustrates a prior imaging flow cytometer trained convolutional neural network 308B being used with transfer learning 310B to form a new imaging flow cytometer trained convolutional neural network 318B. Both methods of forming a new imaging flow cytometer trained convolutional neural network use transfer learning and a small number of image samples in a small IFC dataset. However, the starting trained CNN (e.g., 308A,308B) differs such that different transfer learning techniques are utilized. In FIG. 3A, the usage of an external Non-IFC trained CNN 308A requires a mapping 311 to transfer the parameters associated with the external Non-IFC trained CNN 308A to be the initial network parameters for the IFC CNN. Because of the different datasets used in training and differences in the initial CNN used, the external Non-IFC trained CNN 308A is going to differ from the imaging flow cytometer trained convolutional neural network 308B and the respective parameters that are used in the transfer learning process will differ.

Referring to FIG. 3A, a method is shown for training an IFC CNN model 308B into a trained IFC CNN model 318A using transfer learning. A new untrained external CNN 301A is initially trained on images in a large non-imaging flow cytometer (non-IFC) data set 303A. Initial network parameters 302A are assigned to the CNN 301A. The CNN 301A with these initial parameters 302A undergoes a first model optimization using a large dataset to form an initial trained network with the initial CNN model 301A. An optimization process 304A on the CNN model 301A is performed using the images in a large non-IFC dataset 303A and the initial network parameters 302A. The optimization process 304A results in an external non-IFC trained CNN (trained non-IFC CNN) model 308A. For use with classifying biological cells, a plurality of parameters resulting from training the external non-IFC trained CNN model 308A can be transferred by using transfer learning techniques 310A to become the initial network parameters 312A to retrain an IFC CNN model 308B.

The images in the large non-IFC dataset 303A are typically non-biological images, an image type associated with digital cameras but not associated with imaging flow cytometry (IFC). The three channels associated with these images are typically red, green, and blue such as a jpeg image with a color mode (e.g., greyscale, true color, index color, index color, etc.). Unrelated to small biological cells, the external non-IFC trained CNN model 308A is often trained with these non-biological images, such as vehicles, streets, animals, etc. to recognize or classify what is in the image. Besides selecting one or more model parameters of the external non-IFC trained CNN model 308A to transfer as the initial network parameters 312A, a mapping of the values of the one or more model parameters into the initial network parameters 312A occurs. This is because there are differences in the image data that is used (cellular versus large objects), the type of images being used (e.g., RGB channels versus brightfield/fluorescent channels), and between the CNN that is used (Non-IFC CNN versus an IFC CNN). The mapping can be an averaging, a fractional or other mathematical function that provides improved starting points for training.

The IFC CNN model 308B is retrained during a second model optimization 314A with a smaller more focused dataset of images 313A of biological cells of interest, such as red blood cells or a mixture of healthy and unhealthy cells with DNA damage for example. The second optimization process 314A results in a new IFC trained CNN model 318A that can be used to evaluate the biological cells of interest. This second optimization process 313A can use a smaller dataset in order to more quickly train the IFC CNN 308B into the IFC trained CNN 318A with great accuracy.

But for the new IFC image samples in the new dataset 313A, the algorithms for transfer learning 310A and the pretrained IFC CNN 308B of the method 300A shown in FIG. 3A are available in the AMNIS IFC AI software 399.

Referring to FIG. 3B, a method is shown for training an IFC CNN model 308B into a new trained IFC CNN model 318B using transfer learning. A new untrained internal IFN CNN model 301A can be initially trained on images in a large prior imaging flow cytometer data set 303B. Initial network parameters 302B can be assigned to the CNN 301B. The CNN 301B with these initial parameters 302B undergoes a first model optimization using the large dataset 303B to form a prior trained IFC CNN network 308B. The optimization process 304A on the CNN model 301B is performed using the images in a large non-IFC dataset 303B and the initial network parameters 302B. The optimization process 304B results in a prior pretrained internal IFC CNN model 308B. For the classes for which it was trained, the prior pretrained internal IFC CNN model 308B can be used to classify IFC images of biological cells. However, new classes may be desirable and/or different images of biological cells may be desirable to classify.

For use with classifying biological cells, a plurality of parameters resulting from training the IFC trained CNN model 308B can be transferred using transfer learning techniques 310B to become the initial network parameters 312B to retrain the IFC CNN model 308B.

The images in the large IFC dataset 303A are typically of an image type associated with imaging flow cytometry (IFC). The IFC trained CNN model 308B is trained with images related to small biological cells to recognize or classify what is in an IFC image. Given the similarity in the models and the similarity of the images used for training, the transfer learning techniques 310B are simpler. One or more model parameters of the IFC trained CNN model 308B are selected for transfer as the initial network parameters 312B, without a mapping of their values/

The IFC CNN model 308B is retrained during a second model optimization process 314B with a smaller more focused dataset of images 313B of biological cells of interest, such as red blood cells or a mixture of healthy and unhealthy (lymphoma) cells with DNA damage for example. The second optimization process 314B results in a new IFC trained CNN model 318B that can be used to evaluate the biological cells of interest. This second optimization process 314B can use a smaller dataset in order to more quickly train the IFC CNN 308B into the IFC trained CNN 318B with great accuracy.

But for the new IFC image samples in the new dataset 313B, the algorithms for transfer learning 310B, and the pretrained IFC CNN 308B of the method 300B shown in FIG. 3B are available in the AMNIS IFC AI software 399. The small dataset 313B can be added into the AMNIS IFC AI software 399 for subsequent usage.

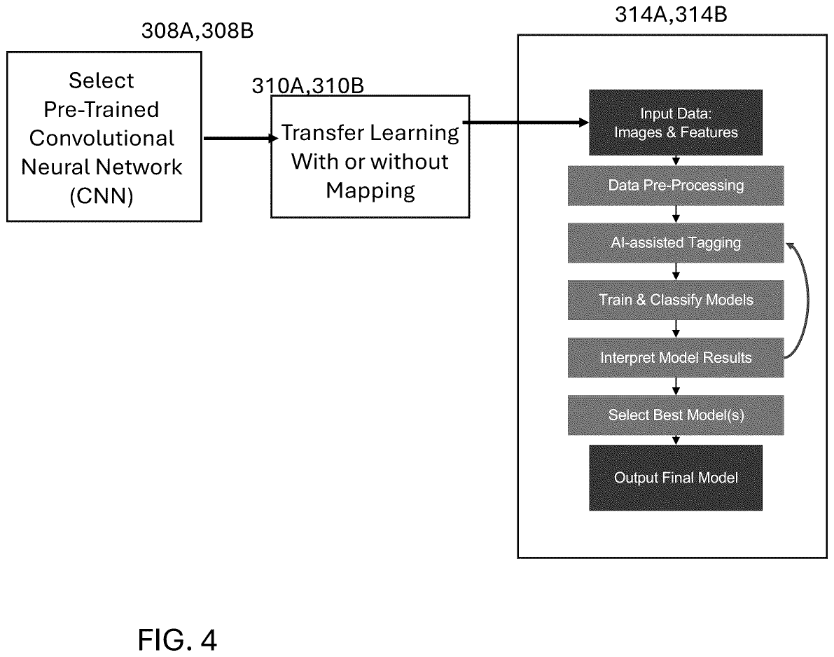

Referring now to FIG. 4, a flow chart is illustrated of a method of transfer learning and AI training of a new model with imaging flow cytometer images captured by an imaging flow cytometer. The AI analysis software of the images captured by the imaging flow cytometer provides access to multiple pretrained machine learning models and AI algorithms. One or more of those internal pre-trained CNN models 308B or one more external pre-trained CNN models 308A can be selected to use with transfer learning 310A,310B. The transfer learning 310A,310B changes the analysis/training pipeline (optimization 314A,314B) somewhat as you walk through the data/image analysis process during optimization 314A,314B. Generally, you want to evaluate which model may work best for the experiment you are trying to run with an image flow cytometer.

Input into the optimization process 314A,314B are images and features after the transfer learning process using the pretrained CNN and the new input data. During optimization process 314A,314B, those images and features undergo data pre-processing for the internal model. A user can use AI-assisted tagging to iteratively tag data and use AI-assisted clustering into clusters. However, a user can train different models using different available AI algorithms on the same input data and compare and interpret output results (model results) to determine which AI algorithm and model is better to use in order to select the best model(s). A user can select one or more best model(s) after interpreting the output model results. A user can also output reports of the model results and save the user trained algorithms (output final models) for future classification experiments.

Referring now to FIGS. 3A-3B and 4, methods of speeding training of a convolutional neural network (CNN) to classify images of biological cells captured by an imaging flow cytometer (IFC) are described. In one case, the method includes selecting a trained non-imaging flow cytometer convolutional neural network (non-IFC CNN) from which to acquire trained non-IFC parameters; receiving the trained non-IFC parameters from the trained non-IFC CNN; transfer learning a plurality of the trained non-IFC parameters to form initial network parameters for a first trained IFC CNN; receiving new biological images from a first IFC dataset; receiving new classes to classify the new biological images in the first IFC dataset; and optimizing the first trained IFC CNN to form a second trained IFC CNN for biological images similar to the first IFC dataset. In some cases, the method with transfer learning can further include mapping the trained non-IFC parameters into mapped non-IFC parameters to form the initial network parameters for the first trained IFC CNN. In one case, the mapping can comprise averaging of the trained non-IFC parameters to form the mapped non-IFC parameters. In another case, the mapping can comprise normalizing of the trained non-IFC parameters to form the mapped non-IFC parameters. The new biological images in the first IFC dataset can be captured with an imaging flow cytometer. In this case, the new biological images are multispectral type images of multiple channels including brightfield images and fluorescent images. In another case, the trained non-imaging flow cytometer CNN can be trained using non-biological images in a different image type than the new biological images. For example, the non-biological images are in a red, green, and blue (RGB) image type associated with digital cameras.

In another case, the method of speeding training of a convolutional neural network (CNN) to classify images of biological cells captured by an imaging flow cytometer (IFC) includes: selecting a pretrained imaging flow cytometer convolutional neural network (IFC CNN) from which to acquire pretrained IFC parameters; receiving the pretrained IFC parameters from the pretrained IFC CNN; transfer learning a plurality of the pretrained IFC parameters to form initial network parameters from which to retrain the pretrained IFC CNN; receiving a plurality of new biological images from a second IFC dataset; receiving one or more new classes to classify the new biological images in the second IFC dataset; and optimizing the pretrained IFC CNN to form a retrained IFC CNN for biological images similar to a first IFC dataset based partly on the one or more new classes and the new biological images in the second IFC dataset. The plurality of IFC images of biological cells in a first IFC data set are used to train the pretrained IFC CNN and differ from the plurality of IFC images of biological cells in the second IFC dataset.

The number of new images in the second IFC dataset for training can be varied. In one case, the number of the new IFC images in the second IFC dataset is at least ten or more. In another case, the number of the new IFC images in the second IFC dataset is at least twenty or more. In another case, the number of the new IFC images in the second IFC dataset is at least twenty-five or more. In another case, the number of the new IFC images in the second IFC dataset is at least thirty or more. In another case, the number of the new IFC images in the second IFC dataset is at least thirty-five or more. In another case, the number of the new IFC images in the second IFC dataset is at least forty or more. In another case, the number of the new IFC images in the second IFC dataset is at least forty-five or more. In yet another case, the number of the new IFC images in the second IFC dataset is at least fifty or more. In any case, the number of the new IFC images of biological images in the second IFC dataset is substantially less than the number of the plurality of IFC images of biological cells in the first IFC data set. This allows the user to speed training of the new model.

The new IFC images of biological cells in the second IFC dataset are preferably captured with an imaging flow cytometer. The plurality of IFC images of biological cells in the first IFC dataset can also be captured with the imaging flow cytometer. In another case, the images in the first IFC dataset are non-biological images and may be captured using a digital camera. They can also be in a different image type than the new biological images. For example, the non-biological images are in a red, green, and blue (RGB) image type associated with digital cameras, while the new biological images are multispectral type images of multiple channels including brightfield images and fluorescent images. In some cases, the new IFC images in the second IFC dataset are of biological cells such as red blood cells. In which case, the one or more new classes to classify the biological cells in the second IFC dataset can be one or more of Discocytes, Echinocytes 1 and Echinocytes 2, Stomatocytes, and Sideways cells. In some cases, the new IFC images of biological cells in the second IFC dataset are a mixture of healthy biological cells and lymphoma biological cells with DNA damage. In which case, the new one or more classes to classify the biological cells with DNA damage in the second IFC dataset are Binucleated (BNC), Mitotic, Mononucleated, Mononucleated with micronuclei, and Irregular cells.

Software user interfaces can be used in the methods for training a convolutional neural network (CNN) to classify images of biological cells captured by an imaging flow cytometer (IFC) using transferred learning. A user interface wizard can be displayed on a display device. The user interface wizard can include instructions executable by a processor that when executed performs functions including walking a user through setting up a training experiment in a training mode to train a new model for a desired experiment type on biological cells in a sample; and running a classification experiment in a classification mode to classify cells by cell type and cell morphology with new high resolution multispectral cellular image data. The functions executed by the processor can further include running a plurality of differing biological cells in a biological sample in a stream of fluid through an imaging flow cytometer to capture the new high resolution multispectral cellular image data for the plurality of differing biological cells.

It is desirable to interpret the model results for the two or more selected pretrained CNNs that use new images and data for transfer learning. It may be the case that the output results of one model can inform some information about your data. In may be the case that both selected models are struggling to classify the same classes. That information can be used to go back and revise your tagged data in order to optimize model performance and start to achieve better results with those struggled classes. A flexible machine learning pipeline allows one to find the best model for your data of the IFC experiment one wants to run. All data sets are different. Experiments and desired output results are different. A flexible machine learning pipeline with transfer learning assistance allows the user to adapt to their experimental needs.

A comparison can be made to show that transfer learning works properly. Two main different types of source models can be used for comparison. One external source model is trained on thousands of natural images (dogs, houses, birds, etc.). Another internal source model is trained on images gathered by a CYTEK AMNIS IMAGESTREAM MK II imaging flow cytometer, which are primarily bone marrow aspirates, along with other biological cell images. The parameters of these models were used to initialize a network which was then trained on a dataset of five phenotypes of red blood cells (RBCs). This dataset was chosen because of the importance of measurements of RBCs and because of their relative mono-dispersity in size and shape. Monodispersity often complicates experimental determinations since it is not easy to distinguish phenotypes from measurable characteristics other than shape on a microscopy slide.

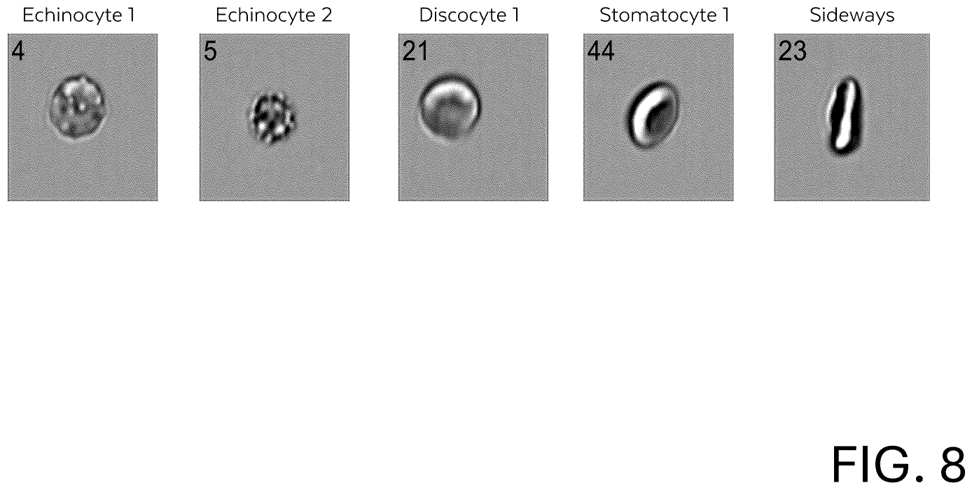

FIG. 8, from left to right, shows representative bright-field images of the five classifications (classes) of red blood cells: Echinocytes 1 and Echinocytes 2 (separated into two classes based on their morphology), Discocytes, Stomatocytes, and Sideways cells that were used for evaluation. Discocytes class can be abbreviated herein as Dsc 1. Echinocytes 1 class and Echinocytes 2 class can be abbreviated herein as Ech1 and Ech2 respectively. Stomatocytes class can be abbreviated herein as Sm1. Sideways cells class can be abbreviated herein as SW. Images in other IFC channels can be used such as side scatter and fluorescent to help in the classification process.

Five models for comparison were trained for 100 iterations with several training data sizes, which consisted of the same number of images for each class and were randomly sampled from a pool of 2,182 images. For each trained model, how each image from a test set was correctly classified independently from its use as a training set was recorded. Every model had its own “test set” which was composed of all data not seen by the model during training. This allowed quantification of the dependence of performance statistics on available data, which is especially important to determine when manual labeling of data by an expert is so time-consuming. The test set did not have a fixed number of images in order to mimic real-life practice: e.g., class “Ech2” had many more examples (e.g., n=867 shown in FIG. 4) than the other classes, while training distributions enforced an equal likelihood of seeing any given class.

The standard model that was compared to as a source network was VGG-16, which was trained on data from the ImageNet competition and has become a widely used benchmark. After comparing other possible such neural networks, including various inception variants, VGG-16 performed the best among these when using a standard fine-tuning algorithm. For comparisons with an imaging flow cytometer (IFC) based model to be meaningful, it was trained only on the bright field images.

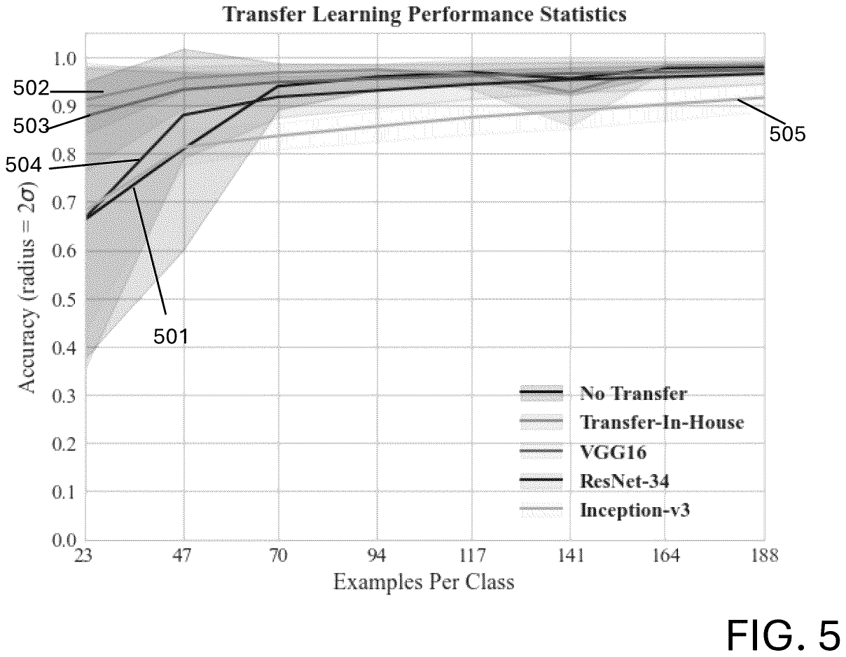

FIG. 5 shows a set of plots 501-505 of normalized accuracy along the Y axis (1.0 be the most accurate) versus examples per class along the Y axis. Generally, one would expect with any model that it would become more accurate with a greater number of examples per class. The plot show in FIG. 5 reports the test accuracy of different models trained with varying numbers of randomly selected sets of labeled images.

To test for the accuracy for of transfer learning we considered a number of different models. Training from scratch (No Transfer), transfer learning (Transfer-In-house) using the AMNIS Al VGG-16-based architecture, the VGG-16′ network itself, ResNet-342, and Inception-v3 model. The black line 501 in the plot represents a model trained without using transfer learning. The green line 502 (transferred learning) in the plot represents a model formed using transfer learning where the model is pre-trained with an-house set of various images of different cells and then finally trained again using red blood cell (RBC). The violet line 503 in the plot represents a model using the VGG-16′ network itself. The purple line 504 in the plot represents a model using ResNet-342. The yellow line 505 in the plot represents a model using Inception-v34.

The shaded area represents a 95% Cl for the accuracy, averaged over 100 runs. The x-axis shows the number of images per class that the model saw during training with an 80-20 split between training and validation. A validation score metric was used to decide which model would be saved. The graph reports accuracy on images not included in the trainings. At around 70 images per class, three curves converge to a similar accuracy. Therefore, we focus further on discussion around this number (70) of images per class. Note that with only 23 to 47 examples per class for training, the green line 502 (transferred learning) shows better than 0.9 (90 %) accuracy. At 70 images per class, the transfer learning model, the VGG-16′ network itself, and the model trained without transfer learning (No Transfer model) seemed to perform better than the ResNet-342 and the Inception-v34 models.

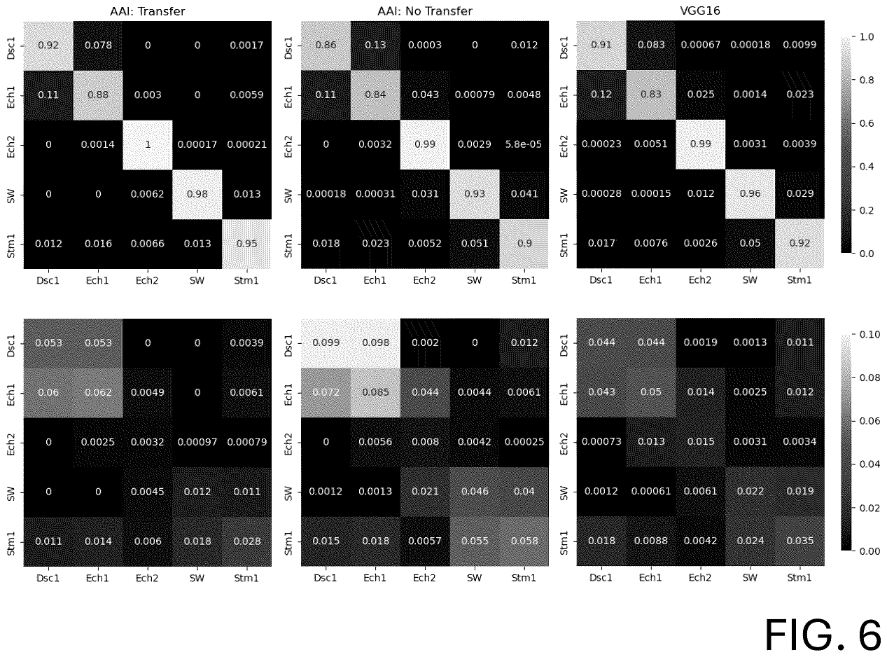

Referring now to FIG. 6, classification statistics are shown for the transfer learning model, the VGG-16′ network itself, and the model trained without transfer learning (No Transfer model). The ResNet-342 and the Inception-v34 models that had poor performances are not shown. The upper matrices are predicative probability matrices for each model and the lower matrices are confusion matrices for each model and can be compared to see what trained model would be better to use. The left pair of upper and lower matrices are associated with the transfer learning model. The middle pair of upper and lower matrices are associated with the no transfer model. The right pair of upper and lower matrices are associated with the VGG16 network model itself.

For each matrix, each row/column pertains to a specific class of red blood cell images, where predictions are in the columns and rows are truth labels. The upper three matrices show the mean proportion of cells (over 100 independent runs) classified as part of a particular class. The lower row of three matrices shows the standard deviation of this number, measuring consistency of results. Each pair of matrices (upper and lower) pertains to a particular model trained from a specific architecture. From this rigorous comparison, we see that the in-house AMNIS Al-based model (transferred learning) performs better than the others, with a similar consistency to VGG-161, a standard source model for TL. Both of these models performed far better than the Inception-v34 or the ResNet-342 based models.

The graph shown in FIG. 5 and the aggregated confusion matrices shown in FIG. 6 demonstrate how the Transfer in-house model performed significantly better and more consistently over other models.

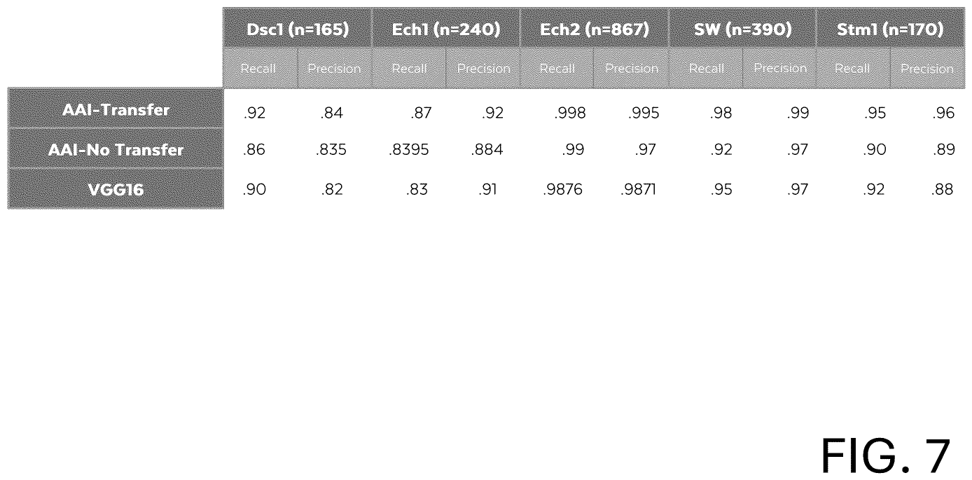

Referring now to FIG. 7, a table shows an average precision and recall metrics for each class (column headings) using the three best trained models (row headings)-the transfer learning model, the VGG-16′ network itself, and the model trained without transfer learning (No Transfer model). The classes Discocytes, Echinocytes 1 and Echinocytes 2 (separated into two classes based on their morphology), Stomatocytes, and Sideways cells can be abbreviated as shown along the X axis of the table with sample number (n) in parentheses. Recall and precision values are tabulated side by side and shown below each class for each trained model.

The first row labeled AAI-Transfer shows the shows average precision and recall metrics for each class using the trained Transfer Learning model. The second row labeled AAI-No Transfer shows the shows average precision and recall metrics for each class using the trained model without Transfer Learning. The third row labeled VGG16 shows the shows average precision and recall metrics for each class using the trained VGG16 model without Transfer Learning.

The recall and precision values for the transfer learning model either exceeds or is substantially equal to those of the VGG16 model and the CNN model formed without transfer learning but using IFC images of biological cells, including the new IFC images of cells in the new data set.

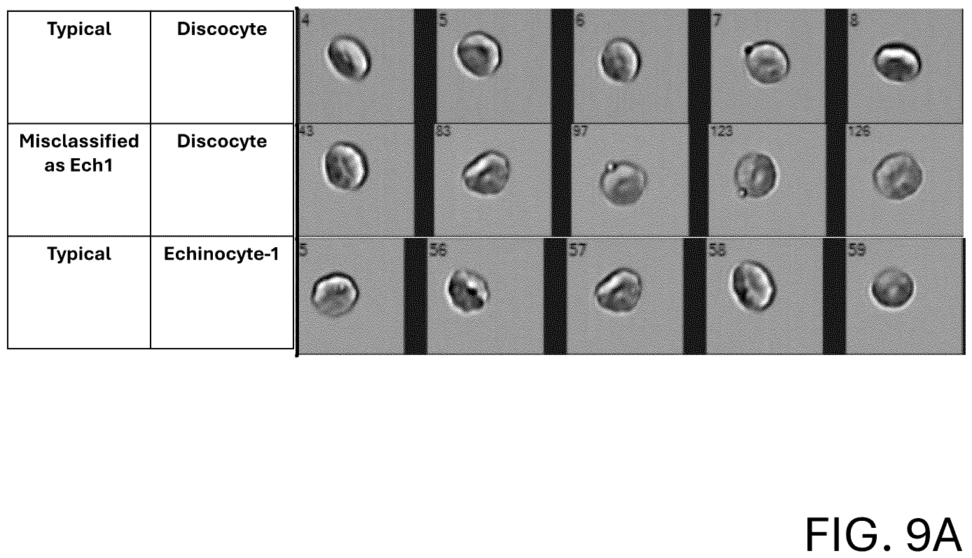

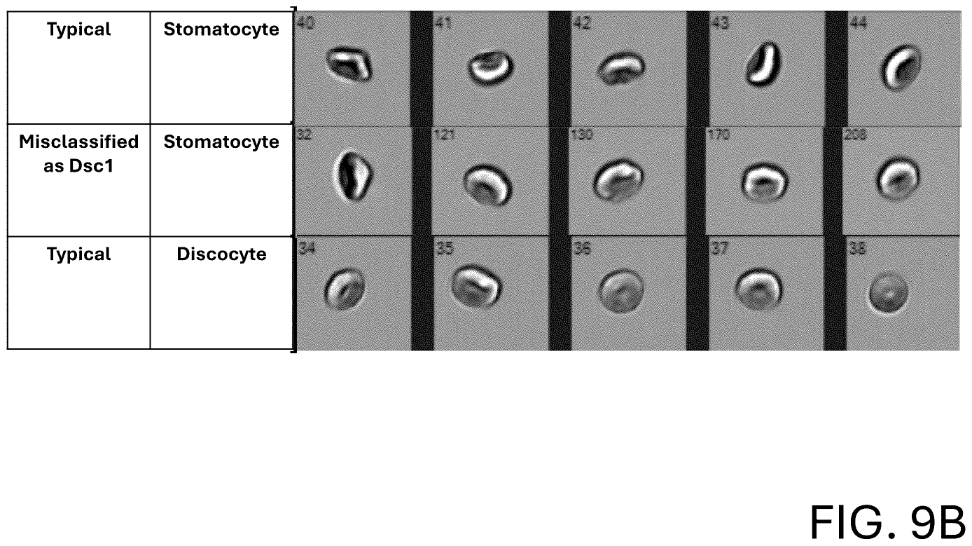

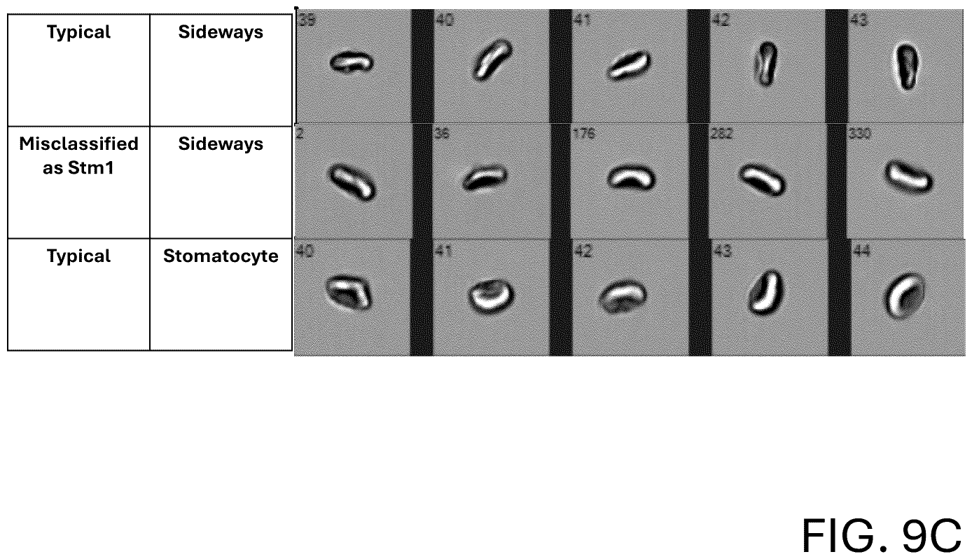

FIGS. 9A-9C display three common misclassifications made by the transfer-learned model using the IFC images as the data for its source model. These three were chosen because they happened with relatively high frequency. Ech2, (not shown) for example, is almost never misclassified as any other class. The first row in each of FIGS. 9A-9C shows typical images of a certain class. The middle row in each of FIGS. 9A-9C shows misclassifications made confidently by the model, marking the same class as the row above as a particular different class. The bottom row of each panel of FIGS. 9A-9C shows typical examples of the class which the model has misclassified those examples as. Seeing these images next to one another, one can see there are apparent morphological similarities between the misclassified examples and the typical examples of the class to which they were assigned.

An evaluation of the classification performance of several deep learning models on data generated by a CYTEK AMNIS IMAGESTREAM MK II imaging flow cytometer using red blood cells with several phenotypic distinctions was performed. The phenotypic distinctions included Discocytes, two maturity stages of Echinocytes, Stomatocytes, and Sideways cells. The dependence of model performance on training data availability was statistically quantified. It was determined that the model that was trained using AMNIS Al with a source model trained on bright field images collected by the CYTEK AMNIS IMAGESTREAM Mk Il imaging flow cytometer consistently outperformed other AI models with, on average, over 90% accuracy in the classification task when the amount of data available per class is small—20-70 images. The misclassifications that were observed were on images bearing superficial similarity to the class in which they were misclassified. Users can exploit this information and tag several more examples for model retraining, thus improving the ability of a model to distinguish between the different classes of images.

While transferred learning has been shown to be used to reduce the training requirements for red blood cells, transferred learning can also be used to reduce the training requirements for other classes of biological cells as well. For example, transferred learning can be used to train a CNN model to recognized and predict classes of DNA damage to cells in a sample.

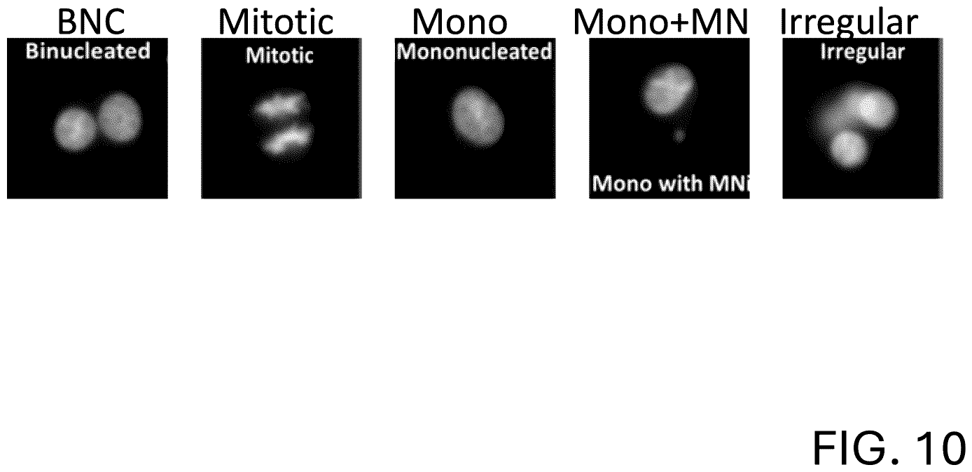

FIG. 10 illustrates representative bright-field images of five classes of DNA damage of cells that AI models can be trained to recognize and predict in images by a transferred learning process. The DNA damage classifications (classes) include Binucleated (BNC), Mitotic, Mononucleated, Mononucleated with Micronuclei (MONO+MN); and Irregular.

Micronuclei (MN). Irregular. Micronuclei (MN) are extra-nuclear bodies that contain damaged chromosome fragments and/or whole chromosomes that were not incorporated into the nucleus after cell division. These classes can be used to form a new IFC CNN model using transfer learning. A performance comparison can also be made between classification of a predetermined L5178Y cell line with an original Chinse hamster ovary (CHO) model and a transfer learning version of a CNN model that is retrained using just a few of the cells (e.g., 50) from the predetermined L5178Y cell line.

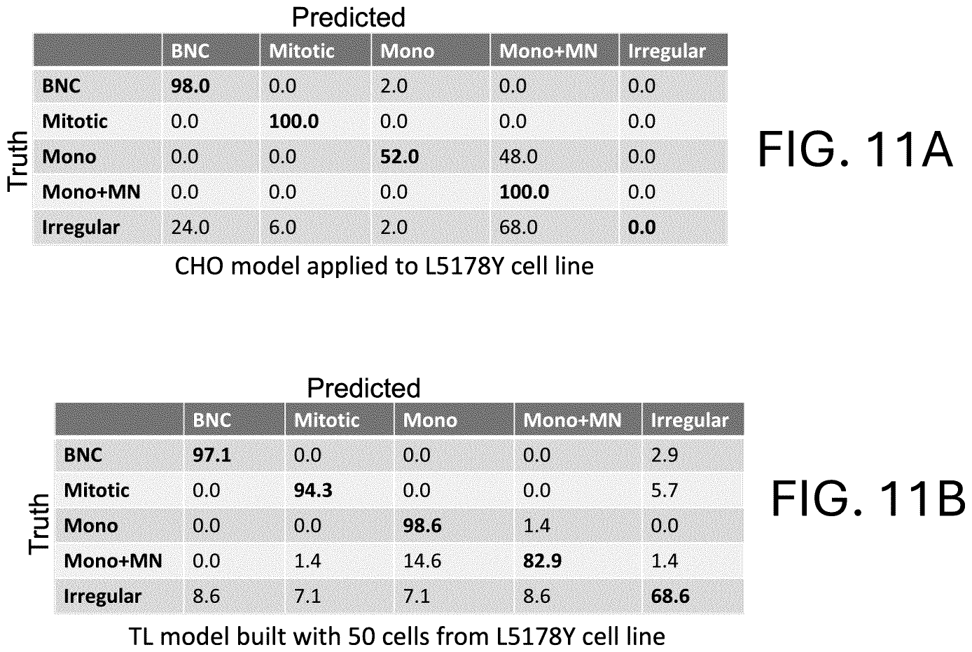

FIG. 11A is a table illustrating statistical prediction of DNA damage classification using a Chinse hamster ovary (CHO) model applied to a predetermined L5178Y cell line. FIG. 11B is a table illustrating statistical prediction of DNA damage classification using a transfer learning model formed using 50 cells from the predetermined L 5178Y cell line. Comparing the tables in FIGS. 11A and 11B, the results for the IFC CNN model formed with transfer learning (FIG. 11B) show improvement over the results for the non-TL trained model (FIG. 11A).

The off-diagonal cells of the matrix shown in FIG. 11A show values of 48 and 24 in two cells indicating confusion for the row/column classifications. The lowest on-diagonal value in one cell of the matrix shown in FIG. 11B is 68.6 while it is 0.0 in FIG. 11A. The 0.0 diagonal value in FIG. 11A shows that the CHO model cannot classify irregular cells.

### Graphical User Interface for Transfer Learning

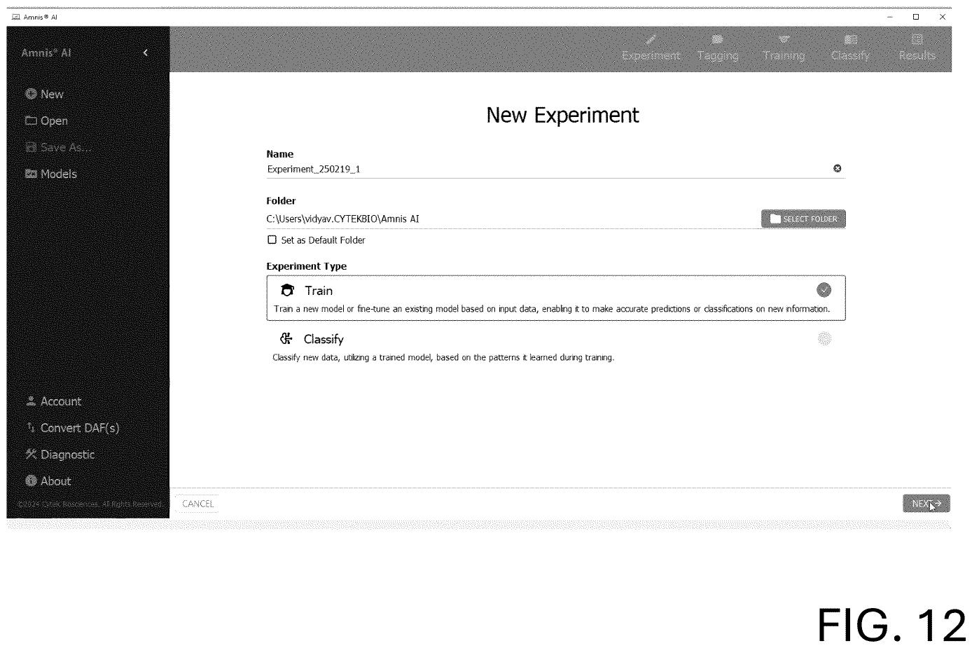

FIGS. 12-15 are window portions of graphical user interfaces (GUI) displayed on a display device to create a new model and a new experiment to analyze new IFC images of biological cells with the AI image analysis device/software. Appendix I filed herewith includes further window portions of the GUI in AMNIS AI analysis software for training, classifying and evaluating the results of training a pretrained CNN with transfer learning.

In FIG. 12, a new experiment window is shown to name the new experiment, the folder where the results of the experiment are to be saved and a selection of the experiment type. A training experiment can be run to train a new AI model or fine tune or retrain an existing model with new input data (new IFC images). A training experiment can also be run to add new classification to a preexisting AI model. Alternatively, a classify experiment can be run to classify new data utilizing a trained AI model. Because it is desirable to train an AI model using transferred learning, the training experiment type is selected.

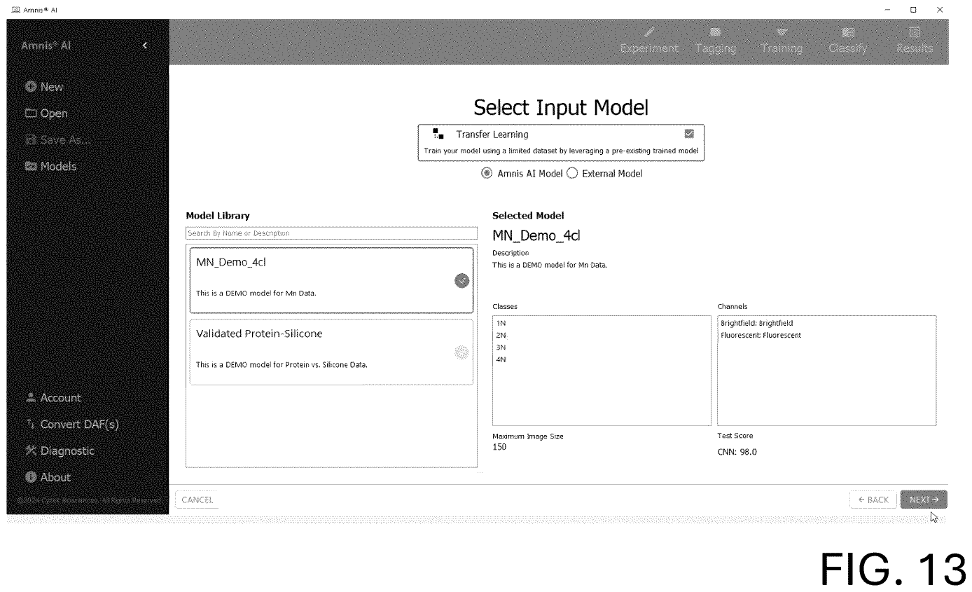

In FIG. 13, the desired input model for training is selected. A check box can be selected for transfer learning where a user can train an IFC AI model using a limited IFC dataset of images by leveraging a preexisting pretrained model. A user hovers a pointer or cursor over the check box and selects the box to indicate a check mark to select transfer learning. If a user wants to train an AI model from scratch, transfer learning is not selected.

Assuming transfer learning is selected, a user can select an AMNIS AI pretrained CNN model or an External AI CNN pretrained model from which to acquire their model parameters for use as the initial input parameters for the new training. The External AI CNN pretrained model is generally trained with non-IFC datasets so it also requires mapping the model parameters from one image type into the IFC image type before being used as the initial training set for retraining an IFC CNN AI model.

If an AMNIS AI model is selected, the AI model library in the AMNIS AI software is shown in a listing a Model Library window area. Advantageously, these models are pretrained with IFC images in IFC datasets, so no mapping is needed of the model parameters. A user can select one of the pretrained AI models such as MN_DEMO_4cl and information about the model can then be displayed in a Selected Model window area for review. The number and type of classes that are defined are shown in a Classes window area. In this case there are four classes labeled 1N, 2N, 3N, and 4N. The type of image channels that are used for the pretrained model are shown in the Channel window area. In this case Bright field channels and Fluorescent channels with the same name respectively. Other image type channels can be associated with the IFC images. Below the Channel window areas is Test Score for the selected CNN model. In this case indicating a score of 98.0 or 98% predictability. A maximum image size in pixels is also indicated. In this case, one hundred fifty pixels is selected.

A next button below each window in the training wizard that can be used to move onto the next GUI window. A back button is below each window in the training wizard that can be used to move back to the previous GUI window. A cancel button is below each window in the training wizard that can be used to cancel the entry of a new experiment and training of a new AI model.

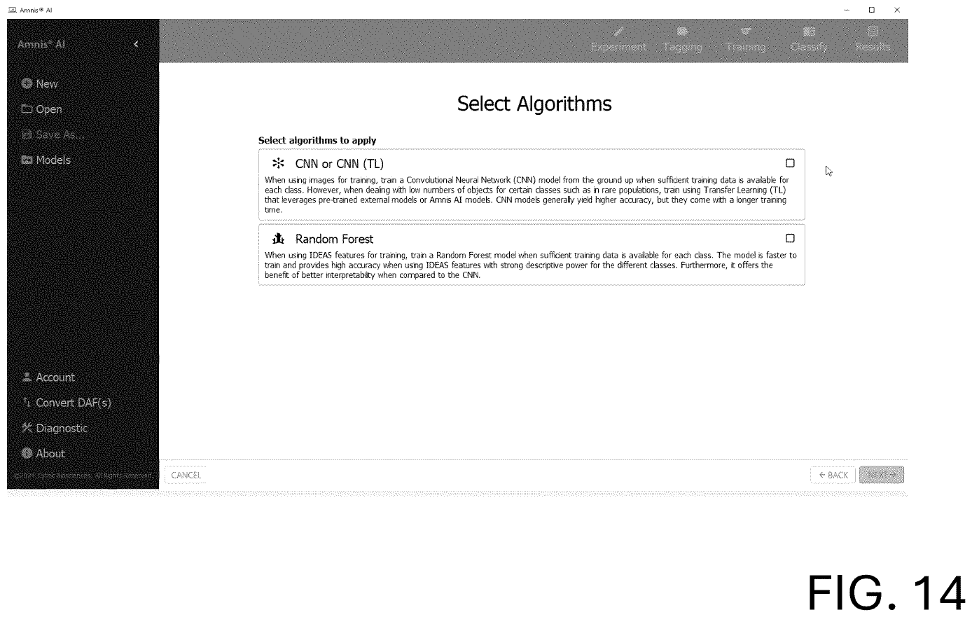

In FIG. 14, a Select Algorithms window is shown for which to train AI models. With only a few images (e.g., 10-50) are available for training, transferred learning is useful. If larger numbers of images are available for training, an IFC CNN can be trained from scratch without using transferred learning. Regardless, the CNN or CNN (TL) is selected for transferred learning. The Random Forest can also be selected if desired to see how well it matches up with the CNN AI model in predictability. Other AI algorithms may be available depending upon the model that is selected.

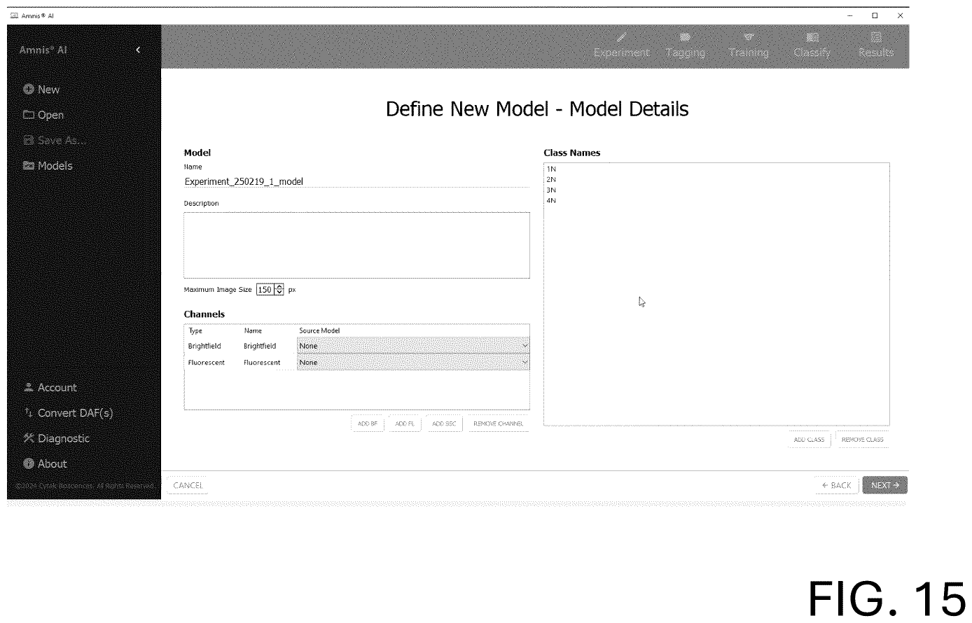

In FIG. 15, a Define New Model window is shown to assign a name to the new retrained IFC CNN model results with transferred learning. A description of the model can be added in the description window. The Channels for the New Model are shown in a Channels window. The channels were previously selected. In this case the list of channels includes a Brightfield type of image and a Fluorescent type of image for each IFC image. A source model field can be selected through a pull down menu adjacent each channel in the list of channels.

There are different types of image channels that can be used. IFC typically includes a brightfield chancel and one or more fluorescent channels of differing colors or wavelength ranges. A side scatter channel could be used to capture an image. A dark field channel could be used to capture an image. Under Channels window area there are ADD and REMOVE CHANNEL buttons to add channels or remove channels from the list in the Channels window area. The ADD buttons include ADD BF to add a brightfield channel, an ADDFL button to add a fluorescent channel, and an ADD SSC button to add a side scatter channel to the Channels list.

The current class names of the New Model are listed in the Class Names window. An ADD CLASS button and a REMOVE CLASS button are available under the Class Names window area in or to add a new class or a remove one of those from the list.

Appendix I is incorporated herein by reference that shows and describes additional GUI windows with window areas of the AMNIS AI analysis software for training models, classifying cellular images and evaluating the results of training a pretrained CNN with transfer learning.

### Image Flow Cytometer

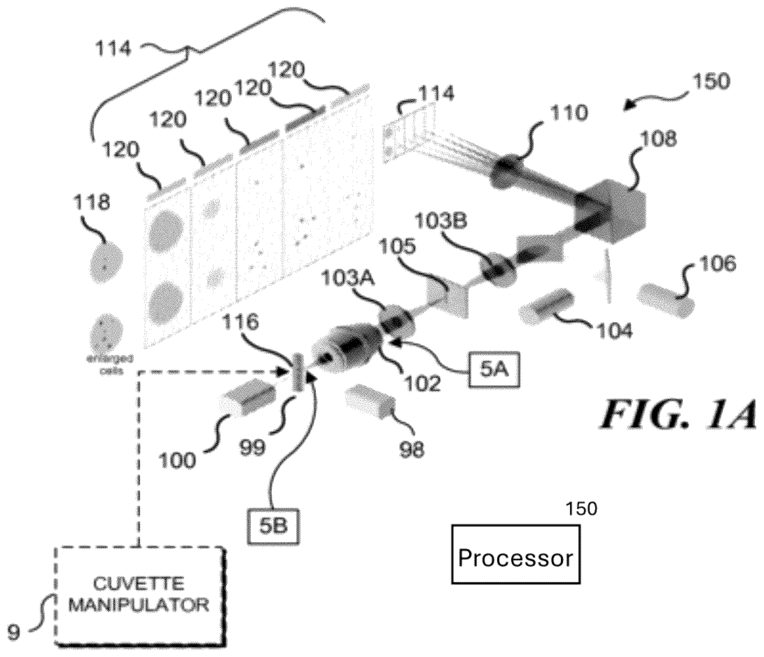

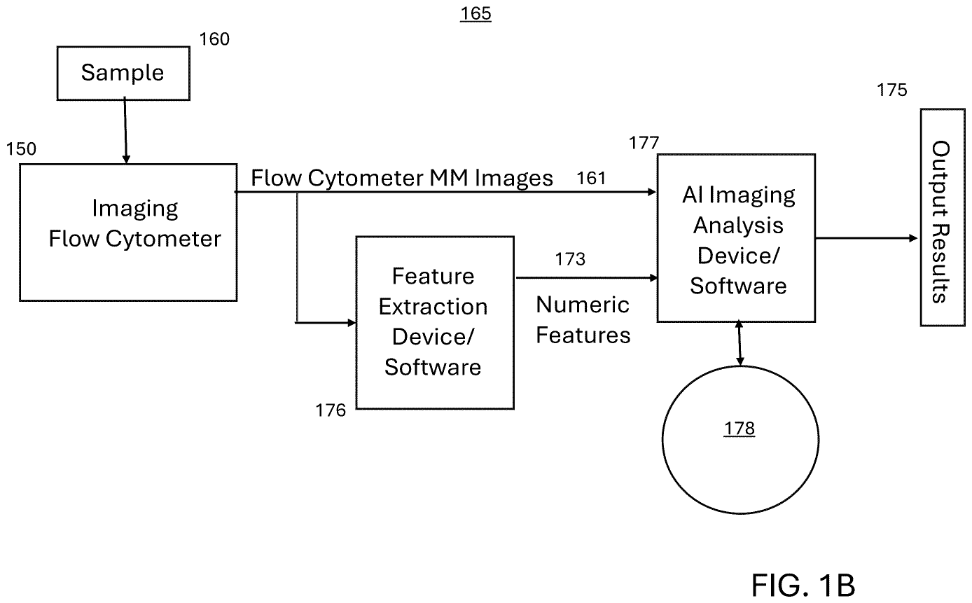

FIG. 1A is a schematic illustration of an exemplary imaging flow cytometer (IFC) system. FIG. 1A illustrates the key components of an optical system employed to project light from objects in flow onto a detector that employs an exemplary readout for any type of small object (although imaging cells represent an exemplary application). Objects are hydrodynamically focused into a single-file line in a fluidic system (not separately shown), forming a tall but narrow field of view. This method enables the lateral dimension of the detector to be used for signal decomposition.

In FIG. 1A, object(s) 99 are hydrodynamically focused in a flow of fluid directed into a flow cuvette 116 into which objects (such as biological cells or particles) to be imaged are directed and illuminated from one or more sides using light sources 98 and 100. Light is collected from the objects with a high NA objective 102, and the light that is collected is directed along a light path including lenses 103A and 103B, and a slit 105. A fraction of this collected light is transmitted to an auto-focus subsystem 104 and to a velocity detection system 106. It should be noted that in connection with a velocity detection system 106 that uses a TDI, it is important to ensure the data signal produced by the detection system, which is integrated over time to increase the signal-to-noise ratio, is properly synchronized with the flow of objects through the imaging system. In the context of an exemplary implementation, the objects are fluorescently labeled beads or fluorescently labeled cells. The extended depth of field capability afforded by the present exemplary technique disclosed herein is particularly useful in automated chromosome enumeration via FISH probing of Jurkat cells, although such use is intended to be exemplary, rather than limiting on the application of this technique.

Either an optical distortion element 5A is disposed between the objects being imaged and the collection lens, or an optical distortion element 5B is disposed in infinite space (that is, at the objective aperture or at a conjugate image of the aperture at a subsequent location in the optical system, but before the detector). Alternatively, optical distortion may be introduced via adjustment of a correction collar on an adjustable implementation of objective lens 102. Only one means of introducing optical distortion is required. The function of the optical distortion is to change the light from the object to achieve a PSF that is substantially invariant across an EDF, such that negative effects of the distortion produced by the element can subsequently be removed by signal processing, to yield an EDF image.

Yet another technique that can be used to introduce optical distortion into light from the object is to use a cuvette/flow cell having different optical thicknesses at different locations, such that imaging through the different locations of the cuvette induces different degrees of wave front deformation. For example, different faces of the cuvette can induce different levels of distortion, with one or more faces introducing no intentional distortion/deformation, with other faces configured to intentionally deform the optical wave front of light from the object. Moving the cuvette relative to the imaging optical enables the deformation to be selectively induced. An optional cuvette manipulator 9 for manipulating the position of the cuvette relative to the optical system is shown in FIG. 1A. Where different faces of the cuvette induce different levels of deformation, such means will generally rotate the cuvette. It should also be recognized that a single face of a cuvette can induce different levels of deformation at different locations, such that translating the cuvette linearly can induce different levels of deformation. In such an embodiment, manipulator 9 will be configured to translate the cuvette linearly. Those of ordinary skill in the art will recognize that many different structural configurations can be used to implement manipulator 9, such as stepper motors, linear actuators, hydraulics, powered hinges, powered linkages, and others. The specific configuration is not critical, so long as manipulation of the cuvette does not introduce additional optical errors beyond the intentional deformation, thus the specified structures for manipulator 9 should be considered exemplary, rather than limiting.

The majority of the light is passed to a spectral decomposition element 108, which employs a fan-configuration of dichroic mirrors 110 to direct different spectral bands laterally onto different regions of a TDI detector 114. Thus, the imaging system is able to decompose the image of a single object 118 into multiple sub-images 120 across detector 114, each sub-image corresponding to a different spectral component. In this view, detector 114 has been enlarged and is shown separately to highlight its elements.

Spectral decomposition greatly facilitates the location, identification, and quantification of different fluorescence-labeled biomolecules within a cell by isolating probe signals from each other, and from background auto fluorescence. Spectral decomposition also enables simultaneous multimode imaging (brightfield, darkfield, fluorescent colors, etc.) using band-limited light in channels separate from those used for fluorescence imaging. FIG. 1A illustrates an exemplary embodiment of an imaging flow cytometer system 150.

The system 150 includes a processor 155 for processing the image data, to enhance the image data and at least partially correct for the distortions introduced by the distortion element. Such processing can comprise a de-convolution that reduces spatial broadening and enhances contrast. It should be recognized that such processing can be implemented using hardware (e.g., a custom processing circuit or an application specific integrated circuit (ASIC)), or a combination of hardware and software (e.g., a software-driven processor, such as is typically used in a computing device, a personal computer being one well-known example thereof). It should further be recognized that the distortion element may be physically located outside of the aperture of the imaging system (i.e. between the flow cell and the imaging objective in the case of the spherical aberration technique), in aperture space after the imaging objective (in the case of the WFC technique), or may be affected within the imaging objective itself by adjustment of an aberration correction collar.

It should be recognized that other elements (such as a prism or a filter stack) could be similarly employed to spectrally disperse the light, and the dichroic mirrors simply represent an exemplary implementation. Imaging flow cytometer system 150 can employ a prism (not shown) or a grating oriented to disperse light laterally with regard to the axis of flow prior to the final focusing optics, for spectral analysis of each object's intrinsic fluorescence. In yet another exemplary embodiment of a suitable flow imaging system that is contemplated (but not shown), a cylindrical final focusing lens can be employed to image a Fourier plane on the detector in the cross-flow axis, enabling analysis of the light scatter angle. These techniques for multi-spectral imaging, flow spectroscopy, and Fourier plane scatter angle analysis can be employed simultaneously by splitting the collected light into separate collection paths, with appropriate optics in each light path. For enhanced morphology or to analyze forward scatter light, a second imaging objective and collection train can be used to image the particles through an orthogonal facet of the flow cuvette 116, thereby viewing the objects in stereoscopic perspective with no loss of speed or sensitivity.

To analyze the collected imagery, a software based image analysis program can be employed. One example of suitable image analysis software is the IDEAS package (available from Cytek Biosciences Corporation, Fremont, CA). The IDEAS software package evaluates over 200 quantitative features for every cell, including multiple morphologic and fluorescence intensity measurements, which can be used to define and characterize cell populations. The IDEAS software package enables the user to define biologically relevant cell subpopulations, and analyze subpopulations using standard cytometry analyses, such as gating and backgating. It should be understood, however, that other image analysis methods or software packages can be employed to apply the concepts disclosed herein, and the IDEAS image analysis software package is intended to be merely one example of a suitable software for this purpose, rather than limiting on the concepts disclosed herein.

The detector 114 of the exemplary flow imaging system shown in FIG. 1A is implemented using a TDI that performs high throughput imaging with high sensitivity. The image on the TDI detector is read out one row of pixels at a time from the bottom of the detector. After each row is read out, the signals in the remaining detector pixels are shifted down by one row. The readout/shift process repeats continuously, causing latent images to translate down the detector during readout over multiple frames T1-T6 of data. If the readout rate of the TDI detector is matched to the velocity of the object being imaged, the image does not blur as it moves down the TDI detector. In effect, the TDI detector electronically “pans” the rate at which rows are read out to track the motion of an object being imaged. To provide optimum results for this technique, it is important to accurately measure the velocity of the objects being imaged and to employ that measurement in feedback control of the TDI readout rate. Thus, accurate velocity detection for objects moving in flow enables the TDI imaging to be implemented properly.

One primary advantage of TDI detection over other methods is the greatly increased image integration period it provides. An exemplary flow imaging system used in connection with the present invention includes a TDI detector that has 512 rows of pixels, provides a commensurate 512.times. increase in signal integration time. This increase enables the detection of even faint fluorescent probes within cell images and intrinsic auto fluorescence of cells acquired at a high throughput. Furthermore, the use of a TDI detector increases measured signal intensities up to a thousand fold, representing over a 30 fold improvement in the signal-to-noise ratio compared to other methods disclosed in the prior art. This increased signal intensity enables individual particles to be optically addressed, providing high-resolution measurement of either scattered spectral intensity of white light or scattered angular analysis of monochromatic light of selected wavelengths.

Exemplary imaging flow cytometer system 150 can be configured for multi-spectral imaging and can operate with, for example, six spectral channels: DAPI fluorescence (400-460 nm), Darkfield (460-500 nm), FITC fluorescence (500-560 nm), PE fluorescence (560-595 nm), Brightfield (595-650 nm), and Deep Red (650-700 nm). The TDI detector can provide 10 bit digital resolution per pixel. The NA of the exemplary imaging system is typically about 0.75, with a pixel size of approximately 0.5 microns. However, those skilled in the art will recognize that this flow imaging system is neither limited to six spectral channels nor limited to either the stated NA, or pixel size and resolution.

FIG. 1B illustrates an artificial intelligence (AI) imaging flow cytometer system 165. The system 165 includes a multispectral imaging flow cytometer 150, a feature extraction device/software process 176, and an AI imaging analysis device/software process 177. The feature extraction device (extractor) 176 and the AI imaging analysis device (analyzer) 177 are both computer implemented devices formed by the execution of software. The AI imaging analysis device (analyzer) 177 is coupled in communication with a storage device 178 to store files of numeric feature data and associated image data, AI models, and training images and data in databases. Deep learning AI models for cell images are often trained with large cell image databases.

A biological sample 160 of interest, such as bodily fluids or other material (medium) carrying subject cells is provided as input int the multispectral imaging flow cytometer 150. The imaging flow cytometer 150 combines the fluorescence sensitivity of standard flow cytometry with the spatial resolution and quantitative morphology of digital microscopy. An example imaging flow cytometer is the AMNIS IMAGESTREAM manufactured by Applicant. Other imaging flow cytometers that can generate multi-model or multispectral images of each biological cell are suitable.

The imaging flow cytometer 150 is compatible with a broad range of cell staining protocols of conventional flow cytometry as well as with protocols for imaging cells on slides. See U.S. Pat. Nos. 6,211,955; 6,249,341; 7,522,758 and “Cellular Image Analysis and Imaging by Flow Cytometry” by David A. Basiji, et al. published in Clinical Laboratory Medicine 2007 September, Volume 27, Issue 3, pages 653-670 (herein incorporated by reference in their entirety).

The imaging flow cytometer 150 electronically tracks moving cells in the sample with a high resolution multispectral imaging system and simultaneously acquires multiple images of each target cell in different imaging modes. In one embodiment, the acquired images 161 of a cell include: a side-scatter (darkfield) image, a transmitted light (brightfield) image, and a plurality of fluorescence images of different spectral bands. Importantly, not only are the cellular images (i.e., images of a cell) simultaneously acquired but they are also spatially well aligned with each other across the different imaging modes. Thus, the acquired darkfield image, brightfield image and fluorescence images (collectively multispectral images 161) of a subject cell are spatially well aligned with each other enabling mapping of corresponding image locations to within about 1-2 pixels accuracy.

The acquired cellular multispectral images 161 are output from imaging flow cytometer 150 and coupled into the computer-implemented feature extraction device 176 and the computer-implemented AI imaging analysis device 177. For a non-limiting example, embodiments may employ an input assembly for implementing streaming feed or other access to the acquired images 161. The computer-implemented feature extraction device 176 and the computer-implemented AI imaging analysis device 177 can be configured to automatically analyze thousands of cellular images 161 in near real time of image acquisition or access, and to accurately identify different cellular and subcellular components of the sample cells being analyzed. Each multispectral image 161 of a cell has different cellular components and different subcellular components representing cells in the sample. A given cellular component may be formed of one or more image subcomponents representing parts (portions) of a cell.

The acquired cellular multispectral images 161 are coupled into both the feature extraction device 176 and the AI imaging analysis device 177. Numeric features of each cell in each multispectral image 161 are extracted by the feature extraction device 176. Image features of each cell in each multispectral image 161 are extracted by the AI imaging analysis device 177. Advanced shape image features such as contour curvature and bending scope can be determined from a brightfield image in each multispectral image 161. With both numeric features and image features, the AI imaging analysis device 177 can further classify the cell type and cell morphology of each cell in each multispectral image 161. Complex cell morphologies can be determined such as fragmented or detached cells, stretched or pointed cell boundary, etc. in the sample cells.

Based on the numerical feature inputs 173 and the acquired cellular multispectral images 161, the output results 175 of the AI imaging analysis device 177 (and thus system 165) provides indications of identified cell morphologies and/or classification of cell type. A computer display monitor or other output device (e.g., printer/plotter) may be used to render these output results 175 to an end-user.

While an imaging flow cytometer 150 is shown alone in FIGS. 1A-1B, it can be coupled to a network by means of a network interface card or chip (NIC) so that it can be accessed over a computer network and communicate with AMNIS AI analysis software over the computer network by a computer executing the AMNIS AI analysis software. The IFC images can be retrieved from imaging flow cytometer over the computer network. Alternatively, the AMNIS AI analysis software may be provided in a remote computer server in a remote data center to which both the computer and imaging flow cytometer can be coupled in communication. Alternatively, the AMNIS AI analysis software may be provided in a local computer directly coupled in communication with the imaging flow cytometer 150 to gain access to saved IFC images of biological cells.

The embodiments of the invention are thus described. While embodiments of the invention have been particularly described, they should not be construed as limited by such embodiments but rather construed according to the claims that follow below.

While certain exemplary embodiments have been described and shown in the accompanying drawings, it is to be understood that such embodiments are merely illustrative of and not restrictive on the disclosed embodiments, and that the disclosed embodiments not be limited to the specific constructions and arrangements shown and described, since various other modifications may occur to those ordinarily skilled in the art.

1. A method of speeding training of a convolutional neural network (CNN) to classify images of biological cells captured by an imaging flow cytometer (IFC), the method comprising:
selecting a trained non-imaging flow cytometer convolutional neural network (non-IFC CNN) from which to acquire trained non-IFC parameters;
receiving the trained non-IFC parameters from the trained non-IFC CNN;
transfer learning a plurality of the trained non-IFC parameters to form initial network parameters for a first trained IFC CNN;
receiving new biological images from a first IFC dataset;
receiving new classes to classify the new biological images in the first IFC dataset; and
optimizing the first trained IFC CNN to form a second trained IFC CNN for biological images similar to the first IFC dataset.

2. The method of claim 1, wherein the transfer learning a plurality of the trained non-IFC parameters to form initial network parameters for a first trained IFC CNN includes:
mapping the trained non-IFC parameters into mapped non-IFC parameters to form the initial network parameters for the first trained IFC CNN.

3. The method of claim 2, wherein the mapping is one or more of an averaging of the trained non-IFC parameters to form the mapped non-IFC parameters; and
a normalizing of the trained non-IFC parameters to form the mapped non-IFC parameters.

4. The method of claim 1, wherein the new biological images in the first IFC dataset are captured with an imaging flow cytometer.

5. The method of claim 4, wherein the new biological images are multispectral type images of multiple channels including brightfield images and fluorescent images.

6. The method of claim 5, wherein the trained non-imaging flow cytometer CNN was trained using non-biological images in a different image type than the new biological images.

7. The method of claim 6, wherein the non-biological images are in a red, green, and blue (RGB) image type associated with digital cameras.

8. A method of speeding training of a convolutional neural network (CNN) to classify images of biological cells captured by an imaging flow cytometer (IFC), the method comprising:
selecting a pretrained imaging flow cytometer convolutional neural network (IFC CNN) from which to acquire pretrained IFC parameters;
receiving the pretrained IFC parameters from the pretrained IFC CNN;
transfer learning a plurality of the pretrained IFC parameters to form initial network parameters from which to retrain the pretrained IFC CNN;
receiving a plurality of new biological images from a second IFC dataset;
receiving one or more new classes to classify the new biological images in the second IFC dataset; and
optimizing the pretrained IFC CNN to form a retrained IFC CNN for biological images similar to a first IFC dataset based partly on the one or more new classes and the new biological images in the second IFC dataset.

9. The method of claim 8, wherein a plurality of IFC images of biological cells in a first IFC data set are used to train the pretrained IFC CNN and differ from the plurality of IFC images of biological cells in the second IFC dataset.

10. The method of claim 9, wherein a number of the new IFC images in the second IFC dataset is one of at least ten or more; twenty or more, twenty-five or more, thirty or more, thirty-five or more, forty or more, forty-five or more, and/or fifty or more.

11. The method of claim 9, wherein a number of the new IFC images of biological images in the second IFC dataset is substantially less than a number of the plurality of IFC images of biological cells in a first IFC data set to speed training.

12. The method of claim 11, wherein the new IFC images of biological cells in the second IFC dataset are captured with an imaging flow cytometer and the plurality of IFC images of biological cells in the first IFC data set are captured with the imaging flow cytometer.

13. The method of claim 11, wherein the new IFC images of biological cells in the second IFC dataset are red blood cells.

14. The method of claim 13, wherein the one or more new classes to classify the biological cells in the second IFC dataset are one or more of Discocytes, Echinocytes 1 and Echinocytes 2, Stomatocytes, and Sideways cells.

15. The method of claim 11, wherein the new IFC images of biological cells in the second IFC dataset are a mixture of healthy biological cells and lymphoma biological cells with DNA damage.

16. The method of claim 15, wherein the new one or more classes to classify the biological cells with DNA damage in the second IFC dataset are Binucleated (BNC), Mitotic, Mononucleated, Mononucleated with micronuclei, and Irregular cells.

17. A method for training a convolutional neural network (CNN) to classify images of biological cells captured by an imaging flow cytometer (IFC), comprising:
with a user interface wizard displayed on a display device,
walking a user through setting up a training experiment in a training mode to train a new model for a desired experiment type on biological cells in a sample; and
running a classification experiment in a classification mode to classify cells by cell type and cell morphology with new high resolution multispectral cellular image data.

18. The method of claim 17, further comprising:
running a plurality of differing biological cells in a biological sample in a stream of fluid through an imaging flow cytometer to capture the new high resolution multispectral cellular image data for the plurality of differing biological cells.

19. (canceled)
